(19) United States
(12) Patent Application Publication
(10) Pub. No.: US 2012/0107216 A1
(43) Pub. Date: May 3, 2012

(54) HYDROCHLORINATION HEATER AND RELATED METHODS THEREFOR

(75) Inventor: Bruce Hazeltine, Missoula, MT (US)

(73) Assignee: GT SOLAR INCORPORATED, Merrimack, NH (US)

(21) Appl. No.: 12/913,227

(22) Filed: Oct. 27, 2010

(51) Int. Cl. C01B 33/107; B01J 19/00

(52) U.S. Cl. 423/342; 422/129; 422/198

(57) ABSTRACT

The systems and method of the invention involve hydrochlorination by providing feed streams with suitable reaction conditions through reactant stream conditioning systems and components. The conditioning systems facilitate vaporization of silicon tetrachloride in gaseous hydrogen to produce a reactant stream comprising hydrogen that is saturated with silicon tetrachloride. Saturation can be effected without the use of superheated steam or hot oil by utilizing saturated steam that is less than about 15 bar. The saturated reactant stream can be further heated to reaction conditions that effect conversion to trichlorosilane.

### BACKGROUND OF INVENTION

1. Field of the Invention

The present invention relates to systems and methods of producing trichlorosilane and, in particular, to systems and methods that utilize vaporization techniques to reduce the energy consumption of and improve the availability of trichlorosilane reaction systems.

2. Discussion of Related Art

Coleman, in U.S. Pat. No. 4,340,574, disclosed a process for the production of ultrahigh purity silane with recycle from separation columns.

Breneman, in U.S. Pat. No. 4,676,967, disclosed a process for producing high purity silane and silicon.

Burgie et al., in U.S. Pat. No. 5,118,486, disclosed separation by atomization of a byproduct stream into particulate silicon and silanes.

Oda, in U.S. Pat. No. 6,060,021, disclosed a method of storing trichlorosilane and silicon tetrachloride under a hydrogen gas as a sealing gas.

Klein et al., in U.S. Pat. No. 6,843,972 B2, disclosed a method of purifying trichlorosilane by contacting with solid bases.

Block et al., in U.S. Pat. No. 6,852,301 B2, disclosed a method of producing silane by reacting metallurgical silicon with silicon tetrachloride, SiCl₄, and hydrogen, to form a crude gas stream of trichlorosilane, SiHCl₃, and silicon tetrachloride; removing impurities from the crude gas stream by washing with condensed chlorosilanes; condensing and separating the purified crude gas stream by distillation; returning the partial stream of silicon tetrachloride to the reaction of metallurgical silicon with silicon tetrachloride and hydrogen; disproportionating the partial stream to form silicon tetrachloride and silane; and returning the silane formed by disproportionation to the reaction of metallurgical grade silicon with silicon tetrachloride and hydrogen.

Block et al., in U.S. Pat. No. 6,905,576 B1, disclosed a method and system for producing silane by catalytic disproportionation of trichlorosilane in a catalyst bed.

Bulan et al., in U.S. Pat. No. 7,056,484 B2, disclosed a method for producing trichlorosilane by reacting silicon with hydrogen, silicon tetrachloride, with the silicon in comminuted form mixed with a catalyst.

Kajimoto et al., in U.S. Patent Application Publication No. 2007/0231236 A1, disclosed a method of producing halosilane and a method of purifying a solid fraction.

Andersen, et al., in International Publication No. 2007/035108 A1, disclosed a method for the production of trichlorosilane, and for producing silicon for use in the production of trichlorosilane.

### SUMMARY OF THE INVENTION

One or more embodiments of the invention can be directed to a method of preparing trichlorosilane. The method can comprise contacting a first stream comprising hydrogen with a second stream comprising silicon tetrachloride to produce a gaseous reactant stream comprising hydrogen saturated with silicon tetrachloride, introducing the gaseous reactant stream into a reactor, and recovering a product stream comprising trichlorosilane, silicon tetrachloride, and hydrogen from the reactor. The method of preparing trichlorosilane can further comprise heating at least a portion of the first stream. In some embodiments of the invention, heating the at least a portion of the first stream can comprise heating with saturated steam having a pressure in a range of from about 5 bar to about 15 bar. The method of preparing trichlorosilane can further comprise, prior to introducing the gaseous reactant stream into the reactor, heating at least a portion of the reactant stream to a temperature in a range of from about 175° C. to about 550° C. In some embodiments of the invention, contacting the first stream with the second stream can comprise heating at least a portion of at least one of the first stream and the second stream. The method of preparing trichlorosilane can further comprise recovering at least a portion of the hydrogen from the product stream and utilizing at least a portion of the recovered hydrogen to produce the first stream.

One or more embodiments of the invention can be directed to a method of providing a reactant mixture. The method can comprise providing a gaseous first reactant, providing a liquid reactant, vaporizing the liquid reactant by providing at least a heat of vaporization to at least a portion of the liquid reactant to produce a gaseous second reactant, recovering the reactant mixture comprising the gaseous first reactant saturated with the gaseous second reactant, and introducing at least a portion of the reactant mixture into a reactor. The method of providing a reactant mixture can further comprise heating the reactant stream to a temperature in a range of from about 175° C. to about 550° C. The method of providing a reactant mixture can further comprise increasing a latent heat of the gaseous first reactant with saturated steam. In some embodiments of the invention, the first reactant can comprise, consist essentially of, or consist of hydrogen. The second reactant can comprise, consist essentially, or consist of silicon tetrachloride. Vaporizing the liquid reactant can be performed while reducing the latent heat of the gaseous first reactant.

One or more aspects of the invention can be directed to a reactor system. The reactor system can comprise a contactor having a first reactant inlet fluidly connected to a source of a gaseous first reactant, a second inlet fluidly connected to a source of a liquid second reactant, a reactant mixture outlet, and a vaporization region; and a reactor having a reactor inlet fluidly connected downstream from the reactant mixture outlet, and a reactor product outlet. The reactor system can further comprise a heat exchanger having a first thermal side fluidly connecting the reactant mixture outlet and the reactor inlet, and a second thermal side fluidly connected downstream from a reactor product outlet. The reactor system can further comprise a heater fluidly connecting the reactant mixture outlet and the reactor inlet. The reactor system can further comprise a control system configured to regulate a temperature of the reactant mixture to be introduced into the reactant inlet of the reactor to be in a range of from about 500° C. to about 600° C.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing.

In the drawings:

FIG. 1 is a schematic illustration of a reactor system in accordance with one or more embodiments of the invention;

FIG. 2 is a schematic illustration of a portion of a reactor system upon which one or more embodiments of the invention may be practiced; and

FIG. 3 is a schematic illustration of a portion of a contacting system that may be used with the reactor system in accordance with one or more embodiments of the invention.

### DETAILED DESCRIPTION

Hydrochlorination reactors typically operate at high pressures and temperatures, in a range of from about 20 bar to about 40 bar and from about 550° C. to about 580° C. One or more aspects of the invention facilitate providing a feed stream or a reactant stream to the reactor at about the reaction conditions. Thus, for example, the reactor system of the present invention can comprise at least one pretreatment or conditioning system disposed to receive one or more reactants and render the one or more reactants at conditions that promote hydrochlorination.

Some aspects of the present invention facilitate or promote hydrochlorination by providing feed streams with suitable reaction conditions. Further aspects of the invention involve providing economically favorable hydrochlorination systems. One or more particular embodiments of the invention involve hydrochlorination systems and techniques that comprise reliable and energy efficient reactant stream conditioning systems and components. Further aspects of the invention can provide hydrochlorination reactant streams that are less corrosive than conventional pretreatment systems, which can advantageously reduce capital and operating costs because the use of highly corrosion resistant materials therein may be reduced or avoided. Still further aspects of the invention can provide hydrochlorination systems and techniques with reduced safety hazards.

In some configurations of the invention, the reactor is a fluid bed reactor (FBR) that is pressurized and heated to the reactor operating conditions that promote hydrochlorination.

Some aspects of the invention can involve systems and techniques that economically and efficiently vaporize a liquid reactant, such as, but not limited to, silicon tetrachloride. Further aspects of the invention can provide systems and techniques that vaporize high boiling point liquids with saturated steam systems commonly present in chemical plants. Non-limiting embodiments of the invention can involve vaporizing at least a portion of a liquid reactant with saturated steam at a pressure of less than about 20 bar; in some cases, with saturated steam at a pressure of less than about 15 bar; in other cases, with saturated steam at a pressure in a range of from about 5 bar to about 15 bar. Some aspects of the invention thus avoid limitations or complications associated with utilizing silicon tetrachloride at elevated pressure conditions by avoiding its critical pressure and temperature of 233° C. and 35.8 bar.

Some aspects of the invention involve utilizing heat from one or more product streams from one or more reactors to at least partially heat one or more reactant streams thereinto. Still further aspects of the invention can involve utilizing heat from the one or more product streams from the one or more reactors to vaporize, and in some cases, superheat, one or more reactor feed streams. For example, one or more embodiments of the invention can involve heat interchange processes that raise the temperature of one or more reactant streams by cooling one or more product streams from the reactor. Yet further aspects of the invention can involve utilizing only a portion of heat from the one or more product streams from a reactor to heat the one or more reactant streams into the reactor. Some aspects of the invention can involve heat transfer between one or more product streams and one or more reactant streams without condensation or deposition of components of any of the one or more product streams. Some embodiments of the invention can involve raising the temperature of one or more reactant streams while cooling one or more exhaust product streams without deposition or desublimation of metal salts therein.

One or more aspects of the invention can involve heating one or more reactant streams into a reactor in a plurality of heating stages. Particular embodiments of the invention can involve a first heating stage to raise the temperature of a first reactant, a second reactant, such as a second reactant stream, or both. In further particular embodiments of the invention, the latent heat of the first reactant stream can be utilized to raise the temperature of the second reactant stream or to effect a phase change of at least a portion of the second reactant stream. Still further particular embodiments of the invention can optionally involve a second heating stage to raise the temperature of any one or more of the first reactant, the second reactant, or both, after heating any of such streams in the first heating stage. Yet further particular embodiments of the invention can involve heating, in a third or final stage, any of the reactant streams to be introduced into one or more reactors to reaction favorable conditions. Further aspects of the invention can involve saturating one or more reactant streams with one or more other reactant streams during any of the heating stages. Still other aspects of the invention involve providing a portion of the total heat energy to a reactant mixture to be introduced into a reactor by utilizing saturated steam, and providing another portion of the total heat energy with heat energy from a product stream of the reactor. Still further aspects of the invention can involve systems and techniques that do not utilize a heater between an interchanger, which utilizes heat from a reactor product stream, and the reactant mixture inlet of the reactor.

First stage heating can involve providing directly or indirectly at least a portion of heat of vaporization of one or more reactants. A gaseous first reactant stream can be heated by one or more heat sources, and the heated first gas stream can then transfer heat to a liquid second reactant stream. A liquid second reactant stream can optionally be directly heated by one or more heat sources. The heated gas reactant stream can contact or be mixed with a liquid second reactant stream to provide heat of vaporization thereto and vaporize at least a portion of the second reactant. Further variants of one or more embodiments of the invention can involve heating the first reactant that is in contact with or mixed with the second reactant. First stage heating can involve heating any of the reactant streams, or a mixture thereof, with saturated steam. Further variants of first stage heating embodiments can involve heating a gaseous first reactant stream while in contact with one or more other reactants to produce a gaseous reactant mixture stream with the first reactant that is saturated with the one or more other reactants. Heat for the first stage heating, such as, but not limited to, the heat of vaporization of a liquid reactant, can be provided by conventionally available heating fluids. For example, saturated steam can be utilized to provide the sufficient heat of vaporization to saturate a gaseous first reactant with a liquid second reactant. The saturated steam can be less than about 20 bar, in some cases, less than about 15 bar, in other cases, in a range of from about 5 bar to about 20 bar, and in yet other cases, in a range of from about 5 bar to about 15 bar.

The optional second stage heating can involve raising the temperature of the gaseous reactant stream to at least an intermediate target temperature by utilizing one or more heating systems to raise the temperature of the one or more reactant streams to the intermediate target temperature. For example, the reactant stream can be heated by utilizing an electrical heating source. In other cases, second stage heating can utilize any of saturated steam and superheated steam to raise the temperature of the reactant stream to the intermediate target temperature. Oil-based heating systems can alternatively be used to raise the temperature of one or more preheated reactant streams to the intermediate target temperature.

In accordance with one or more aspects, advantageous embodiments of the invention can be directed to raising the temperature of the saturated reactant stream or feed gas to a temperature that reduces the likelihood of deposition of a component of a downstream heating stream. The target temperature of the reactant stream just prior to heating in the final heating stage can be a temperature that is above the deposition or condensation condition, e.g. the temperature and pressure, of any component of any of the one or more product streams from the reactor. In hydrochlorination reaction systems, for example, the target temperature can be considered an intermediate target temperature which can be, depending on the depositable metallic salts present in the product stream, at least about 175° C., and in some cases may be in a range of from about 175° C. to about 500° C., in a range of from about 175° C. to about 400° C., in a range of from about 175° C. to about 350° C., or even in a range of from about 200° C. to about 375° C.

Final heating of the feed gas to be introduced into any one or more of the reactors can be effected by heat interchange with one or more effluent streams from one or more unit operations of the system, such as any of the one or more reactors, to provide conditions that favor one or more reaction products.

Various aspects of the invention can thus provide operationally cost effective systems and techniques that involve stages to condition or provide reactant streams with one or more target properties. Further aspects of the invention provide systems and techniques that can avoid the use of hot oil systems or electrical heating systems to vaporize one or more reactants. Still further aspects of the invention provide systems and techniques that can utilize heat from a unit operation thereof, such as a hot stream, to raise the temperature of another process stream of the system, such as a cool stream, at conditions that do not cause or at least reduce the likelihood of deposition or condensation of any component in the hot stream.

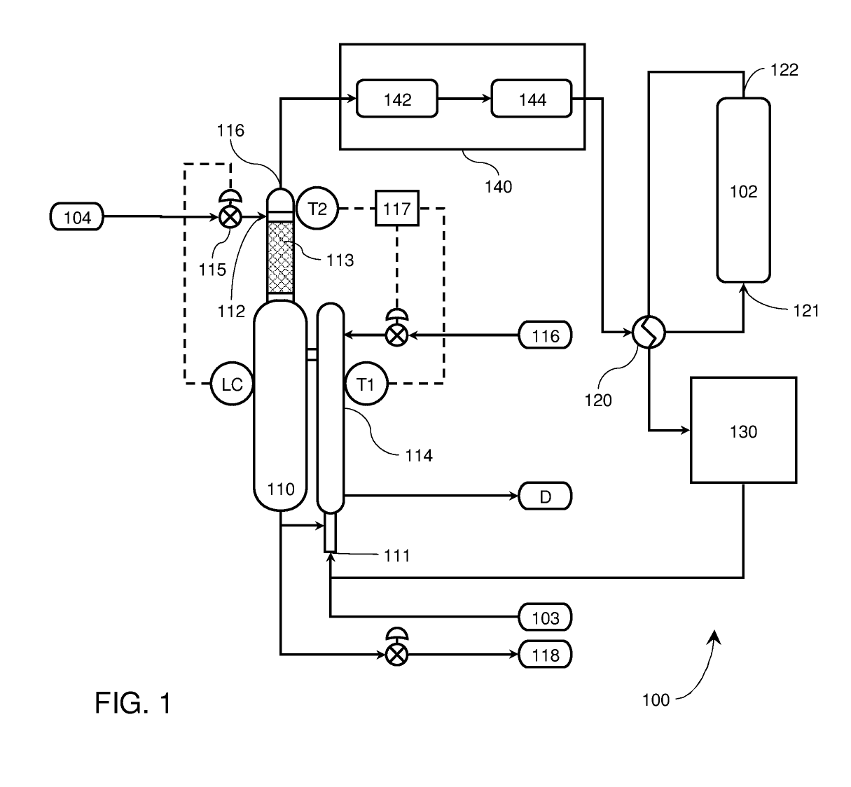

As exemplarily illustrated in FIG. 1, which shows a portion of a reaction system 100 for producing trichlorosilane, the systems and techniques of the present invention can comprise at least one reactor, such as a fluid bed reactor 102 that is operated at reaction conditions that produce trichlorosilane from a source 103 of a first reactant and a source 104 of a second reactant. For illustrative purposes, the systems and techniques will be described for trichlorosilane reaction systems but is not limited as such. The reaction system 100 can also comprise at least one reactant contacting unit operation and one or more heat exchanging or heating unit operations. As illustrated in the non-limiting embodiment of FIG. 1, the contacting unit operation can be a thermosiphon reboiler 110 that has at least one gaseous reactant inlet 111 which is typically fluidly connected downstream from a source of a gaseous reactant, such as source 103 of the first reactant comprising, consisting essentially of, or consisting of hydrogen. The contacting unit operation can also have at least one liquid reactant inlet 112 which is typically fluidly connected downstream from a source of a liquid reactant, such as source 104 of the second reactant comprising, consisting essentially of, or consisting of silicon tetrachloride. The contacting unit operation typically has at least one saturation or liquid/gas vaporizing zone or section 113 which promotes equilibrium conditions between gaseous and liquefied components. Vaporization section 113 can comprise packing materials that promote mass transfer, preferably saturation of the gas with the liquid components. For example, silicon tetrachloride of the second reactant stream can evaporate into the hydrogen stream to saturation conditions in section 113. The contacting unit operation can further comprise a heating section that facilitates heating of any of the reactants. As exemplarily illustrated, saturated steam from steam source 116, which can provide saturated steam at a pressure in a range of from about 5 bar to about 15 bar, can be utilized. Any condensate from the saturated steam can be discharged to a drain D or be recycled, reused, and converted to saturated steam. The contacting unit operation can further comprise a blowdown 118 to periodically remove any undesirable accumulating components.

In operation, the liquid level in reboiler 110 can be controlled to a desired liquid level by utilizing, for example, a closed loop level control system LC that comprises at least one level sensor or indicator operatively coupled to a flow regulator, such as valve 115 that is disposed between source 104 of the second reactant typically comprising silicon tetrachloride and liquid inlet 112. The desired liquid level may depend on one or more operational and design consideration of any of reboiler 110 and reactor 102. Non-limiting considerations include, for example, the dynamic response of reboiler 110 to increase or decrease of reactant flow rate into reactor 102, the heating capacity of saturated steam source 116, the heat transfer efficiency of section 114, and the contact efficiency of section 113. The temperature of the saturated reactant stream provided at outlet 116 can be regulated to a desired saturation temperature by utilizing, for example, a closed loop temperature control system 117 that comprises at least one temperature sensor such as sensors T1 and T2. As exemplarily illustrated, sensor T1 is disposed to measure a temperature of a fluid and sensor T2 is disposed to measure a temperature of a vapor in reboiler 110. Like the desired liquid level, the desired saturation temperature may depend on one or more operational and design consideration of any of reboiler 110 and reactor 102 such as, but not limited to, the required or desired mass flow rate of the reactant stream into reactor 102, and the conversion efficiency or capacity of reactor 102. The target or desired saturation temperature is typically less than about 500° C. and can be in a range of from about 125° C. to about 350° C., and typically in a range of from about 135° C. to about 155° C.

As noted, some aspects of the invention involve components and techniques of heating the reactant stream to conditions that favor a desired reaction. For example, system 100 can further comprise an interchanger 120 that facilitates heat transfer from a product stream and an inlet reactant stream to be introduced into reactor 102. As illustrated, interchanger 120 typically has a first thermal side that fluidly connects a reactant stream inlet 121 with outlet 116 of reboiler 110, and a second thermal side which is in thermal communication with the first thermal side and that fluidly connects a product outlet 122 of reactor 102 to one or more downstream unit operations, such as a product separation or purification train 130.

If utilized, system 100 further comprises a supplemental or second heating stage 140 with at least one heating unit operation that raises the temperature of the saturated reactant stream from reboiler 110 to the intermediate target temperature. Second stage heat energy can be provided by utilizing direct or indirect heating operations. For example, heating stage 140 can comprise any one or both of a first heater 142 that provides heat energy from hot oil heat and a second heater 144 that provides electrically generated heat energy to provide a reactant stream, which is to be further heated in interchanger 120, with the intermediate target temperature. In the exemplary system, the intermediate target temperature can be a temperature that is above the deposition temperature of any depositable salts in the product stream from reactor 102. For example, the intermediate target temperature can be in a range of from about 175° C. to about 350° C. If advantageous, second stage heating can be effected by utilizing steam, such as superheated steam.

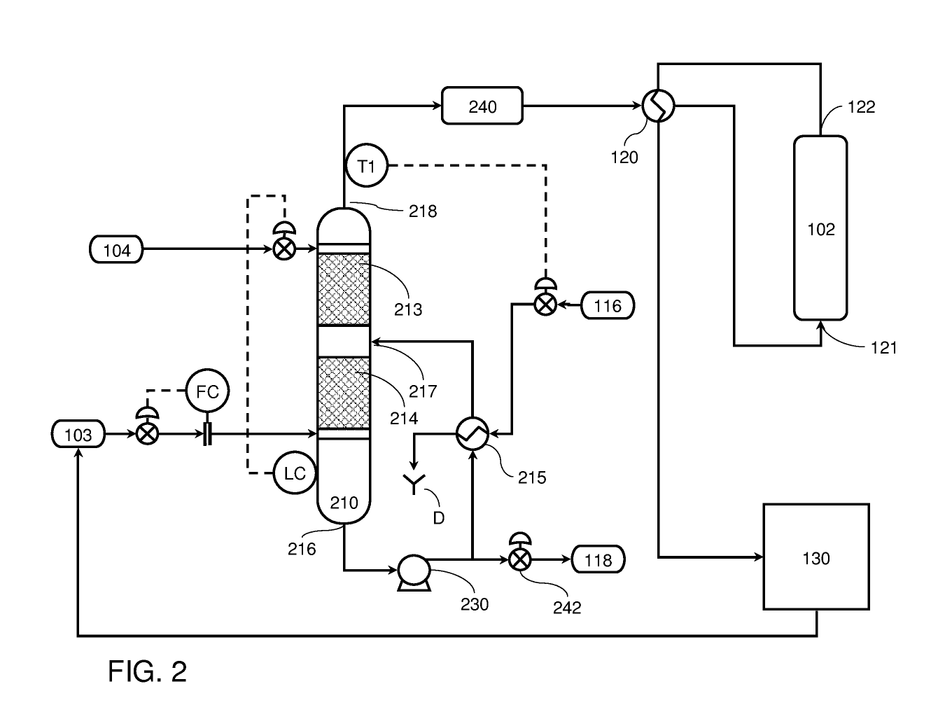

FIG. 2 exemplarily shows another variant of one or more embodiments of the invention. In this variant, saturation of the gaseous reactant stream from source 103 can be facilitated by utilizing a contacting column 210 with one or more saturation sections 213 and vaporization sections 214. Each of sections 213 and 214 typically comprises packing components that facilitate liquid/gas transfer. System 100 can further comprise one or more heaters 215 having a first thermal side fluidly connected to a heating source 116 providing saturated steam in a range of from about 5 bar to about 15 bar. Each of the one or more heaters 215 typically has a second thermal side that is in thermal communication with the first thermal side and fluidly connected to a liquid outlet 216 of column 210 through a bottoms circulation pump 230 and with a heated liquid inlet 217 of column 210. As heated liquid typically comprising the second reactant, such as silicon tetrachloride, is introduced into section 214, at least a portion of the second reactant is vaporized into the gas phase which is introduced into section 213. In section 213, the gas phase becomes saturated with the vaporized first reactant prior to exit through saturated reactant outlet 218.

As in the first variant, a valve 242 can be utilized to periodically discharge accumulated contaminants to discharge or blowdown 118.

Similarly, an optional second heating stage 240, which can use any of hot oil, steam, and electrically generated heat apparatus, can be utilized to raise the temperature of the saturated reactant stream from column 210.

The temperature of the saturated reactant stream can be controlled by utilizing a temperature control system with one or more temperature sensors T1 to actuate the amount of heating steam introduced into heater 215. Steam condensate from heater 215 can be discharged to drain D. The liquid level in the sump or bottoms section of column 210 can be controlled to a target level by a liquid control system LC, which actuates a valve that regulates a flow rate of the second reactant stream, based on a measured liquid level by one or more sensors. The flow rate of the second reactant stream can likewise be controlled. The flow rate of the first reactant stream into column 210 can be controlled to a target flow rate by a flow control system FC which actuates a valve that regulates a flow rate of the second reactant stream based on a measured flow rate by one or more flow sensors.

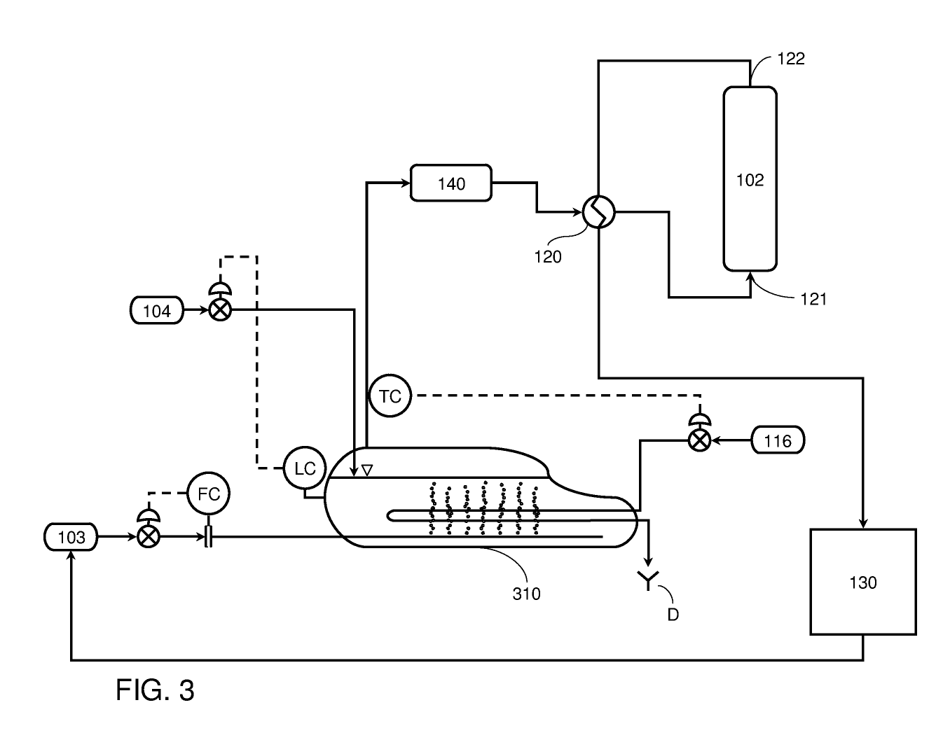

FIG. 3 shows another variant of one or more embodiments of the invention. As exemplarily illustrated, the system can comprise a kettle reboiler 310 to facilitate contact of the first reactant from source 103 with the second reactant from source 104 to produce a saturated reactant stream which can be further heated by the product stream from reactor 102, in interchanger 120.

Saturated steam from source 116 can be utilized to heat any hydrogen, silicon tetrachloride, or both in reboiler 310. Any condensate from the saturated steam can be transferred from the heating coils into a drain D or be reheated to saturated steam.

The gaseous first reactant from source 103 is typically contacted with the first reactant by bubbling the gaseous reactant in a pool of the liquid second reactant within reboiler 310. Bubbling can be effected by utilizing a manifold with a plurality of apertures, submerged below the liquid second reactant. As the gaseous first reactant rises through the liquid second reactant, a portion of the second reactant vaporizes into the bubbles of the gaseous second reactant. A headspace above the liquid level thus comprises gaseous first reactant that is saturated with the second reactant, which can then be heated in interchanger 120 by a product stream from reactor 102.

If utilized, second heating stage 140 can raise the temperature of the saturated reactant stream to the intermediate target temperature.

Train 130 can comprise one or more separation unit operations that fractionate components of the product stream from reactor 102. For example, train 102 can comprise one or more distillation columns that separate one or more desired products, such as trichlorosilane, from unused reactant, such as gaseous hydrogen and silicon tetrachloride, in the product stream. The desired product can be stored, delivered, or utilized in other systems. The recovered reactants, such as hydrogen and silicon tetrachloride, can be utilized or supplement any of sources 103 and 104 of reactants.

The present invention can also involve utilizing one or more control systems to monitor and regulate operation of one or more parameters of any unit operation of the system. For example, the control system can be utilized to monitor and regulate operating conditions of any of the unit operations of system 100 to respective target values. In some cases, the same or a different control system can be utilized to monitor and regulate operating conditions in any of the unit operations of the system. For example, the flow rate of the contact gas stream can be monitored and be controlled to provide one or more predetermined, target, or set point values, or to be dependent on other operating conditions of one or more other unit operations. Other monitored or controlled parameters can be the temperature, the pressure, and the flow rates of any of the streams.

The controller may be implemented using one or more computer systems, which may be, for example, a general-purpose computer or a specialized computer system. Non-limiting examples of control systems that can be utilized or implemented to effect one or more processes of the systems or subsystems of the invention include distributed control systems, such as the DELTA V digital automation system from Emerson Electric Co., and programmable logic controllers, such as those available from Allen-Bradley or Rockwell Automation, Milwaukee, Wis.

Some aspects of the invention involve the refurbishing or retrofitting of existing system to advantageously incorporate any of the features of the invention. Some particular aspects of the invention can be directed to modifying existing trichlorosilane reaction systems to include techniques directed to contacting a gaseous reactant with a liquid reactant to produce a gaseous reactant mixture that has the first reactant and is saturated with the second reactant. Likewise, some aspects of the invention can involve retrofitting existing reaction systems to reapportion the heating load of one or more reactant streams to utilize saturated steam while reducing the likelihood of undesirable deposition of components of another stream of the system. For example, one or more aspects of the invention can be directed to a method of retrofitting a trichlorosilane reaction system. The method can comprise connecting one or more sources of at least one gaseous reactant that comprises, consists essentially of, or consists of hydrogen, to a liquid-vapor contactor; connecting one or more sources of at least one second reactant that comprises, consists essentially of, or consists of silicon tetrachloride; connecting a reactant mixture outlet of the contactor to a first inlet of a first thermal side of an interchanger; connecting a first outlet of the first thermal side of the interchanger to an inlet of a trichlorosilane reactor. The interchanger typically has a second thermal side that is in thermal communication with the first thermal side, and which has a second inlet that is fluidly connected downstream from an outlet of the trichlorosilane reactor. The method can further comprise connecting an electrical heater between the reactant mixture outlet of the contactor and the first inlet of the interchanger.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of preparing trichlorosilane, comprising:
contacting a first stream comprising hydrogen with a second stream comprising silicon tetrachloride to produce a gaseous reactant stream comprising hydrogen saturated with silicon tetrachloride;
introducing the gaseous reactant stream into a reactor; and
recovering a product stream comprising trichlorosilane, silicon tetrachloride, and hydrogen from the reactor.

2. The method of claim 1, further comprising heating at least a portion of the first stream.

3. The method of claim 2, wherein heating the at least a portion of the first stream comprises heating with saturated steam having a pressure in a range of from about 5 bar to about 15 bar.

4. The method of claim 1, further comprising, prior to introducing the gaseous reactant stream into the reactor, heating at least a portion of the reactant stream to a temperature in a range of from about 175° C. to about 550° C.

5. The method of claim 1, wherein contacting the first stream with the second stream comprises heating at least a portion of at least one of the first stream and the second stream.

6. The method of claim 1, further comprising recovering at least a portion of the hydrogen from the product stream and utilizing at least a portion of the recovered hydrogen to produce the first stream.

7. A method of providing a reactant mixture, comprising:
providing a gaseous first reactant;
providing a liquid reactant;
vaporizing the liquid reactant by providing at least a heat of vaporization to at least a portion of the liquid reactant to produce a gaseous second reactant;
recovering the reactant mixture comprising the gaseous first reactant saturated with the gaseous second reactant; and
introducing at least a portion of the reactant mixture into a reactor.

8. The method of claim 7, further comprising heating the reactant stream to a temperature in a range of from about 175° C. to about 550° C.

9. The method of claim 8, further comprising increasing the latent heat of the gaseous first reactant with saturated steam.

10. The method of claim 9, wherein the first reactant consists essentially of hydrogen and the second reactant comprises silicon tetrachloride.

11. The method of claim 7, wherein providing at least the heat of vaporization is performed while reducing the latent heat of the gaseous first reactant.

12. A reactor system, comprising:
a contactor having a first reactant inlet fluidly connected to a source of a gaseous first reactant, a second inlet fluidly connected to a source of a liquid second reactant, a reactant mixture outlet, and a vaporization region; and
a reactor having a reactor inlet fluidly connected downstream from the reactant mixture outlet, and a reactor product outlet.

13. The reactor system of claim 12, further comprising a heat exchanger having a first thermal side fluidly connecting the reactant mixture outlet and the reactor inlet, and a second thermal side fluidly connected downstream from a reactor product outlet.

14. The reactor system of claim 12, further comprising a heater fluidly connecting the reactant mixture outlet and the reactor inlet.

15. The reactor system of claim 14, further comprising a control system configured to regulate a temperature of the reactant mixture to be introduced into the reactant inlet of the reactor to be in a range of from about 500° C. to about 600° C.
